(19) United States
(12) Patent Application Publication
(10) Pub. No.: US 2006/0015779 A1
(43) Pub. Date: Jan. 19, 2006

(54) Involving a secondary storage system in a data transfer decision

(75) Inventors: Orit Nissan-Messing, Hod Hasharon (IL); Aviad Zlotnick, D.N. Lower Galilee (IL)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/158,843

(22) Filed: Jun. 22, 2005

(30) Foreign Application Priority Data
Jun. 24, 2004 (GB) 0414151.1

(51) Int. Cl. G06F 11/00

(52) U.S. Cl. 714/47

(57) ABSTRACT

Provides methods, systems and apparatus for data storage including running an asynchronous replication process to copy successive sets of stored data from a primary storage system to a secondary storage system, and receiving at the primary storage system from the secondary storage system an indication of space available for receipt of the data at the secondary storage system. An example method further includes selecting from amongst the data stored at the primary storage system one of the sets of the data as a selected set, sized in response to the indication, conveying the selected set from the primary storage system to the secondary storage system in the asynchronous replication process, and storing the sets of the data atomically in the secondary storage system.

### FIELD OF THE INVENTION

The present invention relates to data storage, and specifically to ensuring that data is stored in a consistent manner in a storage facility having multiple storage devices.

### BACKGROUND OF THE INVENTION

Protecting data stored in a data storage facility is becoming increasingly important as storage facilities increase in size and complexity, and as numbers of clients using the facilities increase. Typically, the protection is provided by storing a primary copy and a secondary copy the data. The storing of the data may be considered to be a particular type of transaction.

Methods for processing transactions are very well known in the art. Transaction Processing: Concepts and Techniques, by Gray and Reuter, published by Morgan Kaufmann Publishers, San Mateo Calif. (1993), describes transactions and their processing in detail, and section 1.2, entitled “What Is a Transaction Processing System?” is incorporated herein by reference.

As stated in the above-referenced section 1.2, a transaction has the properties of ‘Atomicity’, ‘Consistency’, ‘Isolation’, and ‘Durability’ (ACID). The atomicity and consistency properties are explained in section 1.2, and may be summarized as follows:
Atomicity Either all changes of state of a system happen or none happen.
Consistency The transaction must result in a correct transformation of the state.

Thus, for a storage facility consisting of a primary storage system and a secondary storage system, which store respective primary and secondary copies of data, the storage must occur atomically and consistently. In other words, the storage facility must store correct and identical primary and secondary copies of the data (consistency); the storage is only considered to be complete when both copies have been stored, and all necessary changes to the storage facility, such as database and log file changes, have been made (atomicity). The concepts of atomicity and consistency may also be applied to elements of the storage facility. For example, the primary system must store the data in an atomic manner, in which case the copy of the data and all necessary changes to databases and log files of the primary system must all be made before the storage at the primary system is considered complete.

To behave consistently a storage facility must preserve the order in which data is stored. For a storage configuration comprising a host coupled to a primary storage system and a secondary storage system, there are two basic order-preserving replication methods known in the art: synchronous replication methods and asynchronous replication methods.

In the synchronous approach, the primary system receives a transaction from the host. The primary system gives no acknowledgment of the transaction to the host until the primary system has completed the transaction, the secondary system has also completed the transactions, and, finally, the primary system has received an acknowledgment of the completion from the secondary system. Only then does the primary system acknowledge completion of the transaction to the host. Synchronous replication processes are inherently order-preserving, regardless of the need for order in transactions being processed on the systems. However, synchronous processes known in the art impose heavy penalties of latency on any system using them, since the primary system must wait for the secondary system to process and acknowledge the transaction. The latency penalties increase as the distance between the primary and the secondary increases, so that, for distances between the systems that are typically of the order of 200 km or more, the degradation to host performance because of the delays in receiving acknowledgments becomes extremely severe.

Asynchronous replication processes allow the primary system to acknowledge the transaction to the host independently of acknowledgment from the secondary system, and thus inherently solve the latency problem of synchronous methods. However, since asynchronous processes are inherently non-order preserving, an order-preserving mechanism must be introduced into systems using these processes. Typically, discrete consistent sets of data are formed at specific times at the primary system, for transfer to the secondary system. The discrete consistent sets of data are termed “colors,” and the formation of a color, such as how often a color is generated, is typically pre-determined by an operator of the storage facility.

### SUMMARY OF THE INVENTION

Thus, the present invention provides methods, systems and apparatus ensuring that data is stored in a consistent manner in a storage facility having multiple storage devices. In a first aspect the present invention provides a data storage facility comprising a primary storage system and a secondary storage system. A host sends data to the storage facility, and the primary storage system in the facility stores the data atomically. The primary storage system also receives, from the secondary system, an indication of space available for receipt of the data at the secondary storage system. The primary storage system selects a set of data from the data it has stored, a size of the selected set being formed according to the indication. The primary storage system then conveys the selected set to the secondary storage system, which stores the selected set, and subsequent sets selected and conveyed in the same manner, atomically. Using knowledge of the space available in the secondary system, to select the data sent by the primary system, significantly reduces the probability of inconsistency developing in the storage facility in the event of a failure.

In an other aspect of the present invention, there is provided a method for data storage including: running an asynchronous replication process to copy successive sets of stored data from a primary storage system to a secondary storage system; receiving at the primary storage system from the secondary storage system an indication of space available for receipt of the data at the secondary storage system; selecting from amongst the data stored at the primary storage system one of the sets of the data as a selected set, sized in response to the indication; conveying the selected set from the primary storage system to the secondary storage system in the asynchronous replication process; and storing the sets of the data atomically in the secondary storage system.

In an other aspect of the present invention, there is provided an apparatus for data storage, including: a primary storage system which is adapted to run an asynchronous replication process that copies successive sets of stored data from the primary storage system; and a secondary storage system which is adapted to receive the successive sets of the stored data, and to convey an indication of space available for receipt of the data at the secondary storage system to the primary storage system, so that the primary storage system selects from amongst the data stored thereat one of the sets of the data as a selected set, sized in response to the indication, and conveys the selected set to the secondary storage system in the asynchronous replication process, and so that the secondary storage system stores the sets of the data atomically.

In an other aspect of the present invention, there is provided a computer software product for performing data storage,

### BRIEF DESCRIPTION OF THE DRAWINGS

The present invention will be more fully understood from the following detailed description of the preferred embodiments thereof, taken together with the drawings, in which:

FIG. 1 is a schematic illustration of a data storage configuration, according to an embodiment of the present invention;

FIG. 2 is a schematic diagram illustrating transfer of data between a host and a storage facility of FIG. 1, according to an embodiment of the present invention;

FIG. 3 shows flowcharts of processes used by a primary storage system of the storage facility of FIG. 1 in determining at which point to send data, according to an embodiment of the present invention; and

FIG. 4 shows flowcharts of alternative processes used by the primary storage system in determining at which point to send data, according to an embodiment of the present invention.

### DETAILED DESCRIPTION OF EMBODIMENTS

Thus, the present invention provides methods, systems and apparatus ensuring that data is stored in a consistent manner in a storage facility having multiple storage devices. In an example embodiment of the present invention, a data storage facility comprises a primary storage system and a secondary storage system. A host sends data to the storage facility, and the primary storage system in the facility stores the data atomically. The primary storage system also receives, from the secondary system, an indication of space available for receipt of the data at the secondary storage system. The primary storage system selects a set of data from the data it has stored, a size of the selected set being formed according to the indication. The primary storage system then conveys the selected set to the secondary storage system, which stores the selected set, and subsequent sets selected and conveyed in the same manner, atomically. Using knowledge of the space available in the secondary system, to select the data sent by the primary system, significantly reduces the probability of inconsistency developing in the storage facility in the event of a failure.

The indication provided by the secondary storage system is typically an actual free space available in a cache of the secondary system. Alternatively or additionally, the indication may incorporate one or more parameters of the secondary affecting reception of data from the primary, such as a de-stage data rate from the cache of the secondary system.

The secondary system normally supplies an acknowledgment to the primary system when the secondary system receives the selected sets. Typically, the secondary system also acknowledges to the primary system when the sets have been successfully stored. The indication may be advantageously conveyed to the primary system with either or both acknowledgments.

As well as using the indication provided by the secondary system, the primary storage system may also use a policy, set by an operator of the storage facility, for forming the sets of data.

There is therefore provided, according to an embodiment of the present invention, a method for data storage including:

running an asynchronous replication process to copy successive sets of stored data from a primary storage system to a secondary storage system;

receiving at the primary storage system from the secondary storage system an indication of space available for receipt of the data at the secondary storage system;

selecting from amongst the data stored at the primary storage system one of the sets of the data as a selected set, sized in response to the indication;

conveying the selected set from the primary storage system to the secondary storage system in the asynchronous replication process; and

storing the sets of the data atomically in the secondary storage system.

Typically, the space available includes space available in a cache of the secondary storage system.

In an embodiment the indication includes a de-staging rate from a cache to a permanent storage system of the secondary storage system.

In an alternative embodiment, receiving the indication at the primary storage system includes conveying the indication from the secondary storage system together with an acknowledgment of completion of a process associated with one of the successive sets. The acknowledgment may include acknowledgment of successful receipt at the secondary storage system of a previous set comprised in the successive sets. Alternatively or additionally, the acknowledgment may include acknowledgment of successful atomic storage in the secondary storage system of a previous set comprised in the successive sets.

The method may include performing an evaluation of the data according to a predetermined primary-storage-system to secondary-storage-system data transfer policy, wherein selecting from amongst the data stored at the primary storage system may include selecting the data in response to the evaluation. In an embodiment, performing the evaluation includes selecting the data according to at least one of:

a time since a previous set included in the successive sets was conveyed to the secondary storage system, and

a volume of the data stored in the primary storage system since the previous set was conveyed to the secondary storage system.

In another example embodiment of the present invention, there is further provided an apparatus for data storage, including: a primary storage system which is adapted to run an asynchronous replication process that copies successive sets of stored data from the primary storage system; and a secondary storage system which is adapted to receive the successive sets of the stored data, and to convey an indication of space available for receipt of the data at the secondary storage system to the primary storage system, so that the primary storage system selects from amongst the data stored thereat one of the sets of the data as a selected set, sized in response to the indication, and conveys the selected set to the secondary storage system in the asynchronous replication process, and so that the secondary storage system stores the sets of the data atomically.

Typically, the secondary storage system includes a cache, and the space available includes space available in the cache.

In an embodiment, the secondary storage system includes a cache and a permanent storage system, and the indication includes a de-staging rate from the cache to the permanent storage system.

Typically, conveying the indication to the primary storage system includes conveying the indication together with an acknowledgment of completion of a process associated with one of the successive sets. In an embodiment, the acknowledgment includes acknowledgment of successful receipt at the secondary storage system of a previous set comprised in the successive sets. Alternatively or additionally, the acknowledgment includes acknowledgment of successful atomic storage in the secondary storage system of a previous set included in the successive sets.

In an alternative embodiment, the primary storage system is adapted to perform an evaluation of the data according to a pre-determined primary-storage-system to secondary-storage-system data transfer policy, and selecting from amongst the data stored at the primary storage system includes selecting the data in response to the evaluation. Typically, performing the evaluation includes performing the evaluation according to at least one of: a time since a previous set included in the successive sets was conveyed to the secondary storage system, and a volume of the data stored in the primary storage system since the previous set included in the successive sets was conveyed to the secondary storage system.

In another example embodiment of the present invention, there is further provided a computer software product for performing data storage, including a computer-readable medium having computer program instructions recorded therein, which instructions, when read by a computer, cause the computer to run an asynchronous replication process to copy successive sets of stored data from a primary storage system to a secondary storage system, receive at the primary storage system from the secondary storage system an indication of space available for receipt of the data at the secondary storage system, select from amongst the data stored at the primary storage system one of the sets of the data as a selected set, sized in response to the indication, convey the selected set from the primary storage system to the secondary storage system in the asynchronous replication process, and store the sets of the data atomically in the secondary storage system.

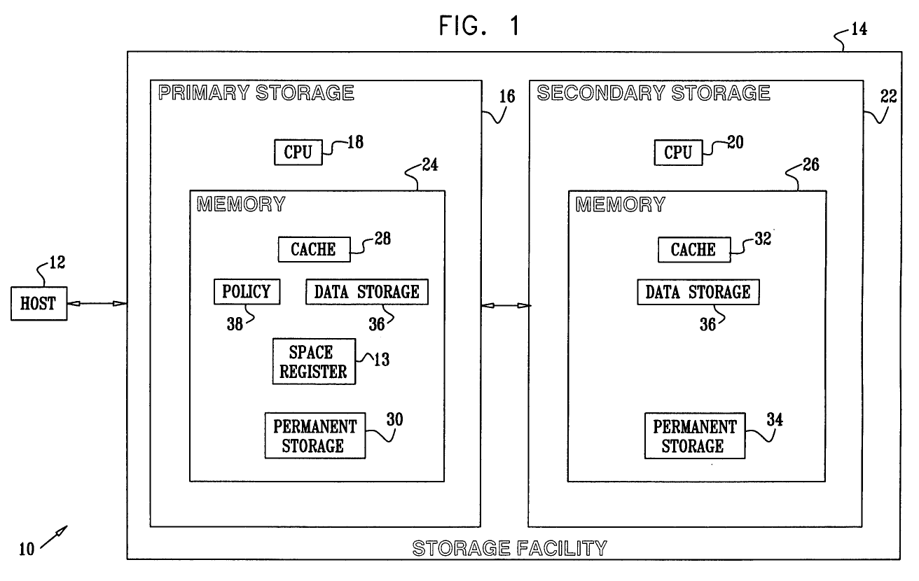

Reference is now made to FIG. 1, which is a schematic illustration of a data storage configuration 10, according to an embodiment of the present invention. Configuration 10 comprises a host computer 12 which is coupled to a data storage facility 14. Data storage facility 14 comprises a primary storage system 16, and a secondary storage system 22, both of which store data received from host 12. Systems 16 and 22 comprise respective central processing units (CPUs) 18 and 20, and respective memories 24 and 26 wherein the data may be stored. Memory 24 typically comprises a relatively fast volatile cache 28 such as a random access memory (RAM), and a relatively slow non-volatile storage memory 30, such as one or more disks, for permanent data storage. Memory 24 also comprises a register 13, the function of which is described in more detail below. Memory 26 typically comprises a cache 32, and a non-volatile storage memory 34 for permanent data storage. Cache 32 and memory 34 are typically respectively generally similar to cache 28 and memory 30.

Data storage facilities such as facility 14 may typically comprise two or more primary storage systems using one secondary storage system, herein termed many-to-one architectures, one primary storage system using two or more secondary systems, herein termed one-to-many systems, and/or combinations of such architectures. For clarity, facility 14 has been assumed to comprise one primary storage system and one secondary storage system, and it will be appreciated that the scope of the present invention includes many-to-one architectures and one-to-many architectures. The memories also have written to them, inter alia, software 36 for performing the data storage, as described hereinbelow. Software 36 may be provided to facility 14 as a computer software product in a tangible form on a computer-readable medium such as a CD-ROM, or as an electronic data transmission, or as a mixture of both forms. In an embodiment of the present invention, a data transfer policy 38, described in more detail below, is written to memory 24 of the primary storage system.

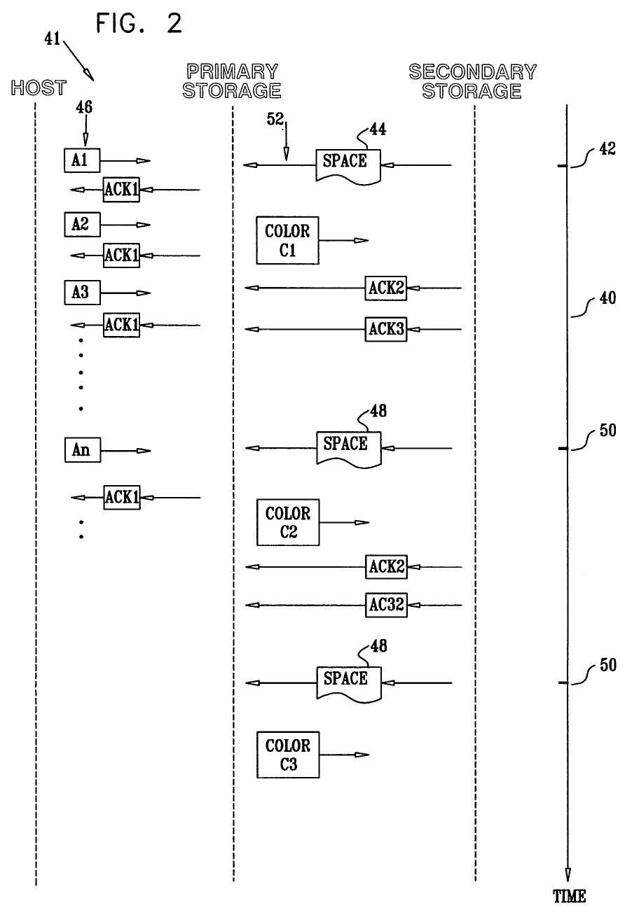

FIG. 2 is a schematic diagram illustrating transfer of data between host 12 and storage facility 14 using an asynchronous replication process 41, according to an embodiment of the present invention. A vertical time axis 40 indicates an initiation time 42 for the beginning of operations of storage facility 14. At time 42, CPU 20 of secondary storage system 22 sends an initial message 44 to primary storage system 16, the message having an indication of an amount of space available for storage in the secondary storage system. Typically, at initiation time 42 the amount of space indicated in the initial message is of the order of the size of cache 32. As described in more detail below, during the course of operation of storage facility 14, secondary system 22 sends further messages 48, each indicating an amount of space available for data storage at the secondary system. Each message 48 is sent at a respective time 50. The amount of space available for storage is stored in register 13, which CPU 18 updates as messages 48 are received.

Also at time 42, host 12 begins to send data 46 to primary storage system 16, for storage in facility 14. The data sent by host 12 is assumed to comprise application level data, although it will be appreciated that the data sent by host 12 may comprise any other type of data that is to be stored in facility 14. Data 46 is assumed to comprise a sequence of data A1, A2, A3, . . . , also herein generically referred to as data An, where n is a natural number. It will be appreciated that data 46 sent by host 12 is typically sent first to cache 28, from where it is later de-staged to permanent storage 30.

As each data An is permanently stored in primary storage system 16, system 16 updates its records, such as database and/or log records, to ensure that the storage of each data An is atomic. An acknowledgment (ACK1) is then conveyed to host 12 to indicate that the storage of data An has been successfully completed.

As primary system 16 continues to receive and store data An, CPU 18 of the system assembles consistent sets 52 of data for successive transfer to secondary system 22. Sets 52 are also herein termed colors C1, C2, C3, . . . . Colors C1, C2, C3, . . . are also referred to generically as color Cn, color Cm, where n, m are natural numbers. U.K. Patent Application 0407257.5, to Factor, which is assigned to the assignee of the present invention and which is incorporated herein by reference, describes a method for maintaining colors and color boundaries in a storage system using an asynchronous updating method.

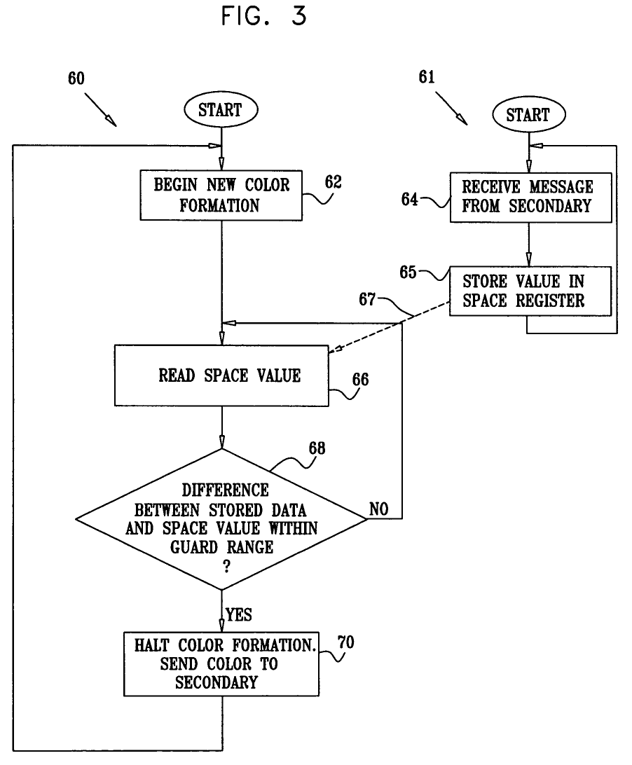

CPU 18 uses message 44 and messages 48 to determine at which point assembly of a specific color Cn is determined to be complete. (The description with reference to FIG. 3 below describes in more detail how the messages are used in generation of a color Cn.) The data comprised within a specific color Cn are chosen from A1, A2, . . . so that the memory they require is less than the space available in secondary system 22. Once a specific color Cn has been assembled, it is transferred from primary system 16 to secondary system 22, and CPU 18 begins assembly of a different color Cm.

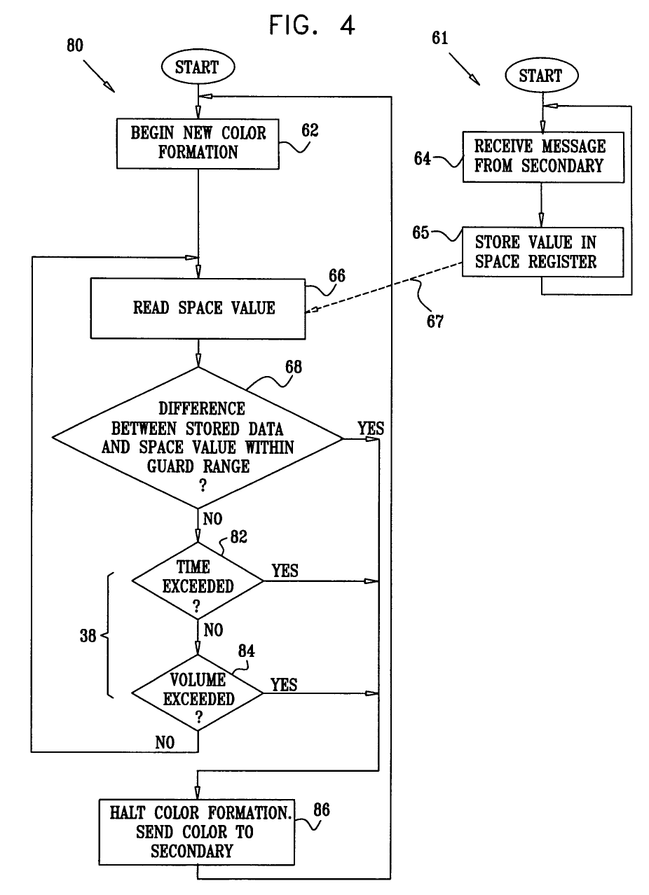

In an embodiment of the present invention, data transfer policy 38 may be used by CPU 18, together with information derived from message 44 and messages 48, in generation of a color Cn, as is described in more detail below with reference to FIG. 4.

Secondary system 22 receives color Cn, typically in its cache 32, and acknowledges receipt of the color in a an acknowledgment (ACK2). On receipt of the color, system 22 begins to permanently store the data comprised in the color to permanent storage 34. Secondary system 22 stores the data of the color atomically, by updating necessary databases and log files in the secondary system. At the conclusion of the atomic storage of color Cn, an acknowledgment (ACK3) is sent to primary system 16.

Messages 48 may be sent at any suitable time from the secondary storage system to the primary system, and are typically sent substantially periodically from the secondary system. Alternatively or additionally, messages 48 may be sent when the space available at the secondary is at one or more pre-determined values, such as at a pre-set fraction of a total available space of cache 32. Further alternatively or additionally, messages 48, rather than indicating an actual size of space available at the secondary system, may indicate an equivalent size of space available. For example, if CPU 20 of the secondary system becomes aware of a reduced rate of de-staging from cache 32 to storage 34, the CPU may reduce the indication of the space in a specific message 48. Such a reduced rate of de-staging may occur, for example, if there is heavy traffic on a local storage area network attached to the secondary system, if an operator of configuration 10 initiates operations on the secondary system, and/or if a partial or total failure of an element of the secondary system occurs.

Messages 48 may be sent independently of, or together with, other data sent from the secondary to the primary. In an embodiment of the present invention, messages 48 are “piggy-backed” with at least one of acknowledgments ACK2 and ACK3.

FIG. 3 is a flowchart of a process 60 and a process 61 used by primary storage system 16 in determining at which point to send a color, according to an embodiment of the present invention. System 16 runs the two processes substantially independently, a result of process 61 being used by process 60. Process 61 acts as a “listening” process, and is typically run on a continuing basis by CPU 18.

In a first step 64 of process 61, primary system 16 receives a message 48, indicating space available at the secondary system, as described above. In a second step 65, CPU 18 determines from the message an actual value of space to be used for the color, and stores the value in register 13.

In a first step 62 of process 60, the primary storage system begins formation of a new color, typically by temporarily storing data received from host 12 that have not already been assigned a previous color and that have not been transmitted to secondary system 22. In a second step 66 CPU 18 reads the value stored in register 13. (This is the value that was last stored in step 65 of process 61.) The reading is indicated by broken line 67.

In a decision step 68, CPU 18 determines a difference between the stored data and the value in register 13. If the difference is within a “guard” region, CPU 18 in a step 70 halts formation of the color and sends the data already stored as a color to the secondary. Process 60 then returns to the beginning of step 62.

The guard range is set by an operator of facility 14, and lies between the value stored in register 13 and a predetermined value less than this value. Typically, the predetermined value is a fixed fraction, such as 90%, of the value in register 13.

If in step 68 the difference is not within the guard range, process 60 returns to the beginning of step 66.

FIG. 4 is a flowchart of an alternative process 80 used, together with process 61 (described above with reference to FIG. 3), by primary storage system 16 in determining at which point to send a color, according to an embodiment of the present invention. As for processes 60 and 61, system 16 runs the two processes 80 and 61 substantially independently. Process 80 comprises step 66, and the value resulting from running process 61 is used in step 66 of process 80, substantially as described above with reference to FIG. 3. Process 80 also comprises steps 62 and 68, as well as steps derived from use of data transfer policy 38 (FIG. 1).

Policy 38 is implemented by CPU 18, and enables the CPU to halt color formation when either a preset time for formation of a color is exceeded, or a preset volume of new data An—not already sent to secondary 22—has been received from host 12. Typically, the preset time and the preset volume are set by an operator of facility 14 at the beginning of the facility's operation. In an embodiment of the present invention, the preset time and/or the preset volume are changed dynamically by CPU 18, typically according to times of reception of acknowledgments ACK2 and ACK3, or by other methods which will be familiar to those skilled in the art.

In process 80, if in step 68 the difference is not within the guard range, a decision step 82 is performed. In step 82, CPU 18 checks if a preset time since formation of a previous color has passed. If the preset time has not passed, then in a further decision step 84, CPU 18 checks if a preset volume of new data An has been received from host 12 since formation of the previous color. If the preset volume has not been received, then process 80 returns to the beginning of step 66.

If the results of any of decisions 68, 82, or 84 are positive, then in a step 86 CPU 18 halts formation of the color and sends the data already stored as a color to the secondary. Process 80 then returns to the beginning of step 62.

It will be appreciated that process 80 exemplifies one policy 38 that may be used with messages received from secondary storage system 22 in order for CPU to evaluate a point at which color formation is to be halted. Those skilled in the art will appreciate that methods for data transfer evaluation other than policy 38 may also be used with messages from the secondary storage system for the CPU to determine the halt point for color formation. For example, the policy may allocate the preset volume in step 84 to be a fraction of the value held in register 13, and the fraction may be fixed or variable. All such data transfer policies are assumed to be included within the scope of the present invention.

It will also be appreciated that by utilizing messages received from secondary storage system 22, primary storage system 16 is able to more effectively determine at which point to halt formation of a color. It will further be appreciated that messages 44 and 48 are indications of space available for storage at the secondary system, and that CPU 18 may compute the value used in register 13 from one or more of the messages, such as by averaging the indicated space available, or by applying one or more parameters of storage facility 14, such as a bandwidth for communications between primary storage system 16 and secondary storage system 22.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for data storage comprising:
running an asynchronous replication process to copy successive sets of stored data from a primary storage system to a secondary storage system;
receiving at the primary storage system from the secondary storage system an indication of space available for receipt of the data at the secondary storage system;
selecting from amongst the data stored at the primary storage system one of the sets of the data as a selected set, sized in response to the indication;
conveying the selected set from the primary storage system to the secondary storage system in the asynchronous replication process; and
storing the sets of the data atomically in the secondary storage system.

2. The method according to claim 1, wherein the space available comprises space available in a cache of the secondary storage system.

3. The method according to claim 1, wherein the indication comprises a de-staging rate from a cache to a permanent storage system of the secondary storage system.

4. The method according to claim 1, wherein receiving the indication at the primary storage system comprises conveying the indication from the secondary storage system together with an acknowledgment of completion of a process associated with one of the successive sets.

5. The method according to claim 4, wherein the acknowledgment comprises acknowledgment of successful receipt at the secondary storage system of a previous set comprised in the successive sets.

6. The method according to claim 4, wherein the acknowledgment comprises acknowledgment of successful atomic storage in the secondary storage system of a previous set comprised in the successive sets.

7. The method according to claim 1, and comprising performing an evaluation of the data according to a pre-determined primary-storage-system-to-secondary-storage-system data transfer policy, and wherein selecting from amongst the data stored at the primary storage system comprises selecting the data in response to the evaluation.

8. The method according to claim 7, wherein performing the evaluation comprises selecting the data according to at least one of:
a time since a previous set comprised in the successive sets was conveyed to the secondary storage system, and
a volume of the data stored in the primary storage system since the previous set was conveyed to the secondary storage system.

9. An apparatus for data storage, comprising:
a primary storage system which is adapted to run an asynchronous replication process that copies successive sets of stored data from the primary storage system; and
a secondary storage system which is adapted to receive the successive sets of the stored data, and to convey an indication of space available for receipt of the data at the secondary storage system to the primary storage system,
so that the primary storage system selects from amongst the data stored thereat one of the sets of the data as a selected set, sized in response to the indication, and conveys the selected set to the secondary storage system in the asynchronous replication process, and
so that the secondary storage system stores the sets of the data atomically.

10. The apparatus according to claim 9, wherein secondary storage system comprises a cache, and wherein the space available comprises space available in the cache.

11. The apparatus according to claim 9, wherein secondary storage system comprises a cache and a permanent storage system, and wherein the indication comprises a de-staging rate from the cache to the permanent storage system.

12. The apparatus according to claim 9, wherein conveying the indication to the primary storage system comprises conveying the indication together with an acknowledgment of completion of a process associated with one of the successive sets.

13. The apparatus according to claim 12, wherein the acknowledgment comprises acknowledgment of successful receipt at the secondary storage system of a previous set comprised in the successive sets.

14. The apparatus according to claim 12, wherein the acknowledgment comprises acknowledgment of successful atomic storage in the secondary storage system of a previous set comprised in the successive sets.

15. The apparatus according to claim 9, wherein the primary storage system is adapted to perform an evaluation of the data according to a pre-determined primary-storage-system-to-secondary-storage-system data transfer policy, and wherein selecting from amongst the data stored at the primary storage system comprises selecting the data in response to the evaluation.

16. The apparatus according to claim 15, wherein performing the evaluation comprises performing the evaluation according to at least one of:
a time since a previous set comprised in the successive sets was conveyed to the secondary storage system, and
a volume of the data stored in the primary storage system since the previous set comprised in the successive sets was conveyed to the secondary storage system.

17. A computer software product for performing data storage, comprising a computer-readable medium having computer program instructions recorded therein, which instructions, when read by a computer, cause the computer to run an asynchronous replication process to copy successive sets of stored data from a primary storage system to a secondary storage system, receive at the primary storage system from the secondary storage system an indication of space available for receipt of the data at the secondary storage system, select from amongst the data stored at the primary storage system one of the sets of the data as a selected set, sized in response to the indication, convey the selected set from the primary storage system to the secondary storage system in the asynchronous replication process, and store the sets of the data atomically in the secondary storage system.

18. The method according to claim 1, wherein:
the space available comprises space available in a cache of the secondary storage system;
the indication comprises a de-staging rate from a cache to a permanent storage system of the secondary storage system;
receiving the indication at the primary storage system comprises conveying the indication from the secondary storage system together with an acknowledgment of completion of a process associated with one of the successive sets;
the acknowledgment comprises acknowledgment of successful atomic storage in the secondary storage system of a previous set comprised in the successive sets, and further comprising performing an evaluation of the data according to a pre-determined primary-storage-system to secondary-storage-system data transfer policy, wherein selecting from amongst the data stored at the primary storage system comprises selecting the data in response to the evaluation, and wherein performing the evaluation comprises selecting the data according to at least one of:
a time since a previous set comprised in the successive sets was conveyed to the secondary storage system, and
a volume of the data stored in the primary storage system since the previous set was conveyed to the secondary storage system.

19. An article of manufacture comprising a computer usable medium having computer readable program code means embodied therein for causing data storsge, the computer readable program code means in said article of manufacture comprising computer readable program code means for causing a computer to effect the steps of claim 1.

20. A computer program product comprising a computer usable medium having computer readable program code means embodied therein for causing data storage, the computer readable program code means in said computer program product comprising computer readable program code means for causing a computer to effect the functions of claim 9.
